(19) United States
(12) Patent Application Publication
(10) Pub. No.: US 2026/0155772 A1
(43) Pub. Date: Jun. 4, 2026

(54) BALLAST FOR SOLAR PANEL MODULES

(71) Applicant: Unirac, Inc., Albuquerque, NM (US)

(72) Inventor: Joseph Bacala, Albuquerque, NM (US)

(21) Appl. No.: 19/406,708

(22) Filed: Dec. 2, 2025

Related U.S. Application Data
(60) Provisional application No. 63/727,792, filed on Dec. 4, 2024.

(51) Int. Cl. H02S 20/23

(52) U.S. Cl. CPC H02S 20/23

(57) ABSTRACT

A ballast that supports solar panel modules. The ballast includes a cavity, a first port, and a second port. The first port is fluidly connected to the cavity and is configured to receive a flowable substance. The second port fluidly connects to the cavity and is configured to interconnect the cavity with an additional cavity of an additional ballast. The cavity is fillable with the flowable substance to provide weight for securing the solar panel modules to a mounting surface.

### CROSS-REFERENCE TO RELATED APPLICATIONS

This application claims priority to U.S. Provisional Patent Application No. 63/727,792, filed Dec. 4, 2024, entitled “Ballast for Solar Panel Modules,” the entirety of which is herein incorporated by reference.

### BACKGROUND

Solar panel modules on rooftops often use ballast systems for stability, typically relying on concrete blocks or sandbags. While effective, these conventional ballasts are heavy, labor-intensive to install and remove, and can cause damage to roofs. Their fixed weight limits adaptability to changing wind conditions, and they may shift over time, compromising stability. Uneven weight distribution and multiple transport trips further increase installation time, costs, and safety risks, especially for large or high-rise projects.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale, and components within the figures may be depicted not to scale with each other.

FIG. 1 illustrates an isometric view of an example ballast, according to an embodiment of the present disclosure.

FIG. 2 illustrates a side view of the ballast of FIG. 1, showing the ballast supporting solar panel modules, according to an embodiment of the present disclosure.

FIG. 3 illustrates a cross-sectional view of the ballast of FIG. 1, taken along line A-A of FIG. 2, showing an example progression to fill the ballast with a substance, according to an embodiment of the present disclosure.

FIG. 4 illustrates a cross-sectional view of the ballast of FIG. 1, taken along line A-A of FIG. 2, showing an example progression to fill the ballast with a substance, according to an embodiment of the present disclosure.

FIG. 5 illustrates an isometric view of example ballasts usable with a mount that supports one or more solar panel modules, according to an embodiment of the present disclosure.

FIG. 6 illustrates an isometric view of an example mounting system that uses the ballasts of FIG. 5, according to an embodiment of the present disclosure.

FIG. 7 illustrates a first isometric view of an example ballast, according to an embodiment of the present disclosure.

FIG. 8 illustrates a second isometric view of the ballast of FIG. 7, according to an embodiment of the present disclosure.

FIG. 9 illustrates an example sequence to stack the ballast of FIG. 7, according to an embodiment of the present disclosure.

FIG. 10 illustrates a cross-sectional view of stacked ballasts that are in fluid connection, taken along line B-B of FIG. 9, according to an embodiment of the present disclosure.

FIG. 11 illustrates an isometric view of an example ballast usable with a mount that supports one or more solar panel modules, according to an embodiment of the present disclosure.

FIG. 12 illustrates an isometric view of an example ballast usable with a mount that supports one or more solar panel modules, according to an embodiment of the present disclosure.

FIG. 13 illustrates an isometric view of an example ballast usable with a mount that supports one or more solar panel modules, according to an embodiment of the present disclosure.

FIG. 14 illustrates a side view of example ballasts usable with a mount that supports one or more solar panel modules, according to an embodiment of the present disclosure.

FIG. 15 illustrates an isometric view of an example mounting system with ballasts that are fluidly connected to one another and/or disposable in a tray, according to an embodiment of the present disclosure.

FIG. 16 illustrates a side view of an example ballast usable with a tray, according to an embodiment of the present disclosure.

FIG. 17 illustrates a side view of an example ballast usable within a tray, according to an embodiment of the present disclosure.

FIG. 18 illustrates a side view of an example ballast usable within a tray, according to an embodiment of the present disclosure.

FIG. 19 illustrates a side view of an example ballast usable within a tray, according to an embodiment of the present disclosure.

FIG. 20 illustrates an example process for installing and filling ballasts, according to an embodiment of the present disclosure.

### DETAILED DESCRIPTION

This application is directed, at least in part, to ballasts that may be filled with a substance to provide stability and support to solar panel modules, according to an embodiment of the present disclosure. The ballasts may be a container with a cavity that is filled or fillable with the substance. In an embodiment, the ballast may be attached to mounts that support the solar panel modules above a mounting surface (e.g., roof). Alternatively, the ballasts may be integrated within the mounts that support one or more solar panel modules. Regardless of the specific embodiment, the substance may be a flowable or pumpable material that fills the ballasts. Using the ballasts as described herein may reduce installation times, complexities, and/or damage resulting from existing ballast systems.

The mounts may be configured to support the solar panel modules above the mounting surface. For example, the mounts may have standoffs, platforms, clamps, brackets, etc., that attach, whether directly or indirectly, to the solar panel modules. In an embodiment, the ballasts may be disposed within a receptacle of the mount, for example. The ballasts may be attached or otherwise secured to the mounts or may rest on portions of the mount. In doing so, the ballast may provide weight to the mount, supporting the solar panel modules.

The ballast, which may be representative of any suitable vessel, housing, etc., forms the cavity into which the substance is disposed. In an embodiment, the cavity may be enclosed or open. The cavity may be representative of a basin, chamber, compartment, tub, trough, etc., into which the substance is disposed. In an embodiment, the cavity may be accessible via a port in the ballast to fill the cavity with the substance. A hose, conduit, etc., may connect to the port, and/or a pump, auger, etc., to deliver the substance into the cavity. Additional ports may be formed in the ballast to vent the cavity. Moreover, the ballast may include more than one port to deliver the substance into the cavity.

Ports may include threaded connections (e.g., NPT threads, BSPT threads, metric threads ranging from ¼″ to 2″) to accept standard hose fittings. Alternatively, ports may include quick-disconnect couplings, such as flat-face couplings, push-to-connect fittings, cam-lock couplings, or proprietary snap-fit designs. In an embodiment, each port may include an integral valve (e.g., ball valve, gate valve, check valve) to prevent backflow or leakage. Certain port embodiments may feature self-sealing mechanisms, including spring-loaded poppet valves, elastomeric sealing membranes, or magnetically actuated closures, that automatically seal when filling equipment is disconnected, eliminating the need for separate caps or plugs. In an embodiment, caps, plugs, and the like may be disposed over the ports when not in use.

In an embodiment, the ballast may include a primary fill port positioned at a top surface, a secondary fill port positioned at a side surface for alternative access, a vent port positioned at an uppermost point to allow air egress during filling, and a drain port positioned at a lowermost point for substance removal. Ports may be positioned to optimize flow dynamics, minimize air entrapment, and facilitate complete filling.

To prevent air lock during filling, ballasts may incorporate dedicated vent ports fitted with one-way valves, breathable membranes, or float-activated vent valves. The vent system may include a standpipe extending from the cavity interior to an elevated position, ensuring venting occurs when the cavity is substantially full. In manifolded systems, a central venting point may serve multiple ballasts.

In an embodiment, the ballasts may be stackable or securable together. For example, several ballasts may be stacked together to generate a combined weight that secures the solar panel modules to the mounting surface. Additionally, or alternatively, the ballasts may be connected end-to-end. The ballast may include interlocking features, such as male-female connectors or keys/keyways, that engage to secure the ballasts together. The interlocking features may be slid into engagement, rotated into engagement, etc. Any number of the ballasts may be interconnected and disposed on the mount (e.g., within the receptacle of the mount). As such, the ballasts may be stackable, interconnectable, or configured for specific mounting system geometries.

Additionally, in an embodiment, ballasts may span between adjacent mounts. For example, a ballast may span between a first mount and a second mount such that a single ballast may support one or more mounts. Alternatively, other apparatuses may be used in conjunction with the ballasts. As an example, a tray may be disposed on the mounting surface, and the mounts may be disposed within the tray or secured to the tray. The ballasts may be contained within the tray, whether within the mount, and/or external to the mount.

In some instances, the ballasts may be shaped and sized according to conventional ballasts in order to be retroactively installed and/or made compatible with existing systems. For example, the ballasts may be 8″×8″×16″, 2″×8″×16″, 4″×8″×16″, 8″×8″×8″, or 2¾″×2¾″×8″. However, other sizes are envisioned. The ballasts may also be rigid or flexible. In the latter, and as an example, the ballast may be a tube-like structure that is contained within a roll, and unrolled across the mounts, or within the tray. The tray may help to contain the ballast to support the solar panel modules.

Instead of being separate from the mount, as discussed above, the ballast may be integrated within the mount. In this instance, the mount and the ballast may be integrated within a single component. For example, the mount may include or form the ballast having the cavity. That is, in addition to having the clamps, standoffs, etc., that support the solar panel module, the mount may include the ballast. The ballast may be integrated within the mount in any suitable manner and may include the cavity for receiving the fluid.

In an embodiment, the ballasts may be fluidly connected to one another, allowing the substance to flow between them. Ports, conduits, quick disconnects, etc., may fluidly connect a first ballast to a second ballast to allow the substance to flow between ballasts. For example, as a first cavity of the first ballast is filled, or becomes filled, the substance may flow to a second cavity of the second ballast. A hose, conduit, etc., may deliver the substance to the first cavity, and other hoses, conduits, etc., may deliver the substance from the first cavity to the second cavity. The first ballast and the second ballast may be disposed on the same mount or different mounts. In an embodiment, the cavities may be filled in parallel (e.g., via a conduit system) or sequentially. Fluidly connecting the ballasts may eliminate the need to fill the ballasts individually.

Additionally, or alternatively, rather than fluidly connecting the cavities, a manifold may be used to fill the cavities. For example, the manifold may deliver the substance to the cavities of the ballasts in parallel or sequentially. The ballasts may be disposed on the same mount or different mounts. A first conduit may fluidly connect to the manifold and deliver the substance to a first cavity of a first ballast, a second conduit may fluidly connect to the manifold and deliver the substance to a second cavity of a second ballast, and so forth. The manifold may fluidly connect to any number of cavities.

In an embodiment, the substance that fills the ballasts may be any suitable material, matter, particulate, aggregate, fluid, etc. As indicated above, the substance may be flowable, pumpable, viscous, etc., to allow the substance to be easily conveyed, moved, or otherwise delivered to the mounting surface. The substance is also capable of being flowable between the ballasts. In an embodiment, for example, the substance may be pumped using tubes, conduit, hoses, etc., vacuumed using tubes, conduit, hoses, etc., or conveyed using belts, chutes, augers, etc. In an embodiment, the cavity may be at least partially filled with the substance prior to transport to the surface. The ease of delivering the substance to the mounting surface may eliminate the need for installers to climb ladders, scaffolding, etc., when carrying the substance. This may not only increase safety during installation but also reduce installation times. Moreover, frequently, cranes, lifts, etc., are used to transport conventional ballasts onto the mounting surface. The use of the substance may eliminate the need for such equipment.

The substance within the ballast may be a solid and/or a liquid. In an embodiment, liquid (or another fluid) may be added to the substance to permit the substance to be pumpable, for example. After being pumped onto the mounting surface and/or into the ballasts, the water may be removed, evaporated, siphoned off, etc. Alternatively, in an embodiment, the substance may be a curable material. For example, before being cured, the substance may be viscous or powdery. After being cured, the substance may be solid.

The substance may include sand (e.g., silica sand, mason sand, play sand), gravel, or crushed stone with any suitable particle size. Recycled materials such as crushed glass, recycled concrete aggregate, or slag may also be used. The particulate substance may be delivered dry using pneumatic conveyance systems, vacuum systems, or auger-based conveyors, or may be delivered as a slurry using centrifugal pumps or positive displacement pumps. Noted above, however, the substance may be pre-installed, or pre-disposed, within the ballast prior to transporting to the surface, after which, additional substances may be added.

The substance may include water-based substances may include additives such as antifreeze agents (e.g., propylene glycol, ethylene glycol) for cold-weather installations, corrosion inhibitors (e.g., sodium benzoate, sodium nitrite), etc. Alternative liquids include brine solutions (e.g., calcium chloride brine, magnesium chloride brine) offering higher density than water, or non-aqueous fluids such as vegetable oils or synthetic fluids for applications where freezing is a concern. In an embodiment, for ballasts in which liquid is added, the liquid may be absorbed or reacted with other substances already present in the ballast or being pumped into the ballasts, to reduce potential damage from spills.

The substance may include hydrogel materials formed by mixing water-absorbent polymers (e.g., superabsorbent polymers, cross-linked polyacrylamide, sodium polyacrylate) with water. The polymer may transform from a dry powder or granular form to a gel state. Gel substances offer advantages, including reduced spillage risk, resistance to siphoning, and the ability to conform to shapes. The gel may be formed in situ by introducing dry polymer to the cavity first, followed by water injection, or may be pre-mixed and pumped as a viscous slurry.

The substance may include concrete mixtures, also termed flowable fill or controlled low-strength material (CLSM) or cement (e.g., Portland cement, fly ash cement, slag cement). Optional additives include set retarders to extend working time, accelerators to reduce cure time, air-entraining agents to improve freeze-thaw resistance, or fiber reinforcement (e.g., polypropylene fibers, glass fibers) to reduce cracking.

In certain embodiments, the substance may include phase-change materials (PCMs) that transition between solid and liquid states at specific temperatures. PCMs may include paraffin waxes, salt hydrates, or fatty acids with melting points selected based on ambient temperature conditions. PCM ballasts offer the additional benefit of thermal regulation, absorbing heat during the day and releasing it at night, potentially improving solar panel efficiency by moderating temperature extremes.

The substance may include combinations of the aforementioned materials. For example, a hybrid substance may include sand (60-70% by volume) suspended in a hydrogel matrix (30-40% by volume), providing both weight density and leakage resistance. Another hybrid may include expanded polystyrene beads (10-20% by volume) mixed with concrete slurry (80-90% by volume) to reduce overall weight while maintaining structural integrity.

In an embodiment, the substance may include a first agent (e.g., chemical, material, etc.) and a second agent (e.g., chemical, material, etc.) that interacts with the first agent. The first agent and the second agent may be mixed and cured to produce the substance that provides weight to the ballasts. Although two agents are described, more than two agents may be mixed to generate the substance. Moreover, the agents may be activated in any suitable manner (e.g., UV, air, heat, water, etc.). For example, the substance may include two-part polyurethane foam systems, where a first component (e.g., isocyanate) and a second component (e.g., polyol blend) are mixed immediately prior to or during injection into the cavity. Upon mixing, the components react and expand. The foam cures to form a rigid or semi-rigid solid. Alternatively, the substance may include single-component foam systems activated by moisture, heat, or UV radiation.

As another example, two materials may be added to produce the substance. For example, a first material, such as a low-strength concrete mixture (e.g., high sand or rock mixture), may be combined with a second material, such as water. The water may cure the low-strength concrete mixture. As another example, the first material may be water-absorbent beads, and the second material may be water that is absorbed by the water-absorbent beads. In an embodiment, the first material may be added to the ballast at a first instance, such as during manufacturing or upon arriving at a jobsite. The second material may be added at a second instance, such as after installation of the ballasts on the mounting surface. For example, water may be added at the second instance to cure the low-strength concrete mixture. In this sense, at least a portion of the substance may be disposed within the ballasts during or before installation.

In an embodiment, the ballasts may incorporate sensing elements, including but not limited to weight sensors, fill-level indicators, pressure transducers, or wireless communication modules for remote monitoring of ballast status. The ballasts may include safety features such as overfill prevention mechanisms, leak detection systems, secondary containment, seismic restraints, and tamper-resistant closures.

The ballasts may be manufactured from suitable materials, including but not limited to high-density polyethylene (HDPE), polypropylene, fiberglass-reinforced composites, rotationally molded plastics, or aluminum alloys. The ballast may be rigid or semi-rigid. In an embodiment, the ballast may be manufactured from a transparent or semi-transparent material to enable visual inspection of the fill level. Suitable manufacturing techniques include blow molding, machining, casting, injection molding, etc.

In an embodiment, the ballast may be manufactured as a single unitary component or two or more separate components that are subsequently assembled to form the complete ballast, such as a first half and a second half that attach together along a parting line, or a base and a lid configuration. The separate components may attach together using mechanical fasteners (bolts, screws, rivets), snap-fit features (interlocking tabs and slots), adhesive bonding, welding techniques (ultrasonic welding, vibration welding, hot plate welding), gaskets or seals positioned between mating surfaces, or compression bands or clamps. Multi-component construction offers advantages, including easier manufacturing of complex internal geometries, the ability to inspect cavity interiors before assembly, simplified repair by replacing damaged components, and potential for field assembly to reduce shipping volume.

In an embodiment, the ballasts may incorporate internal reinforcement, including ribs, gussets, honeycomb cores, corrugated sections, or internal baffles. Reinforcements increase structural rigidity, prevent bulging under load, and may serve as internal flow directors to improve filling efficiency. In liquid-filled ballasts, baffles reduce sloshing and improve stability.

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment or instance may be combined with the features of other embodiments or instances. Such modifications and variations are intended to be included within the scope of the disclosure and appended claims.

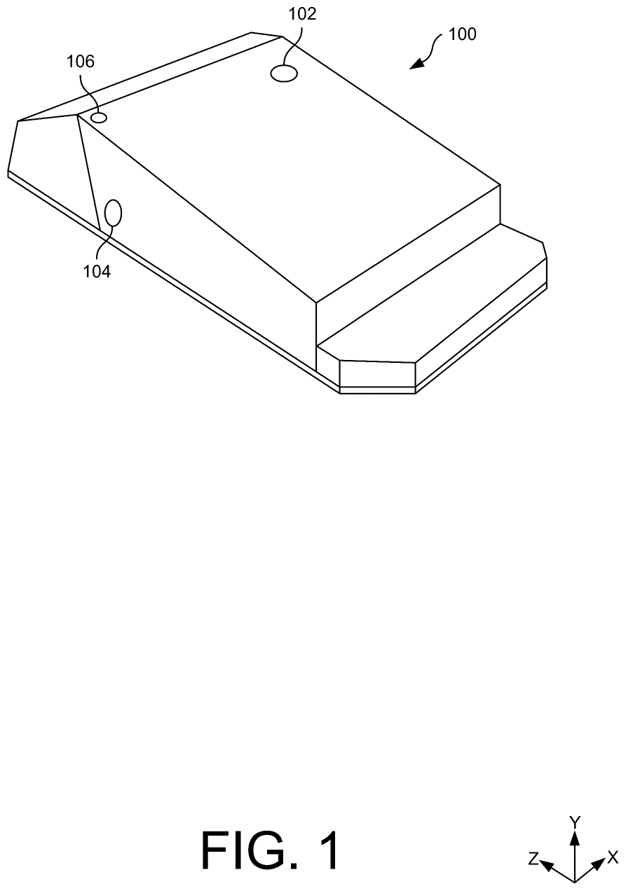

FIG. 1 illustrates an isometric view of an example ballast 100, according to an embodiment of the present disclosure. In an embodiment, the ballast 100 may represent an integrated ballast that supports one or more solar panels. For example, although not shown in FIG. 1, the ballast 100 may include mounts, brackets, standoffs, connectors, etc., that secure one or more solar panels to the ballast 100. In addition, the ballast 100 may include a cavity for receiving a substance. The cavity may receive the substance to provide weight to the solar panel modules to secure the solar panel modules on a mounting surface (e.g., roof).

The ballast 100 may include a first port 102 (e.g., aperture, opening, etc.) and a second port 104 (e.g., aperture, opening, etc.). The first port 102 and the second port 104 may be fluidly connected to the cavity. For example, a hose may fluidly connect to the first port 102 (e.g., via quick connects, threads, etc.) to deliver the substance into the cavity. In an embodiment, the first port 102 may include threads, or a connector may be coupled to, or disposed within, the first port 102. The second port 104 may fluidly connect the cavity of the ballast 100 with another cavity of another ballast. For example, a hose may fluidly connect the second port 104 to a first port of another ballast. In this manner, the ballasts may be fluidly connected together to permit the cavities across the ballasts to be conveniently filled with the substance. When not in use, or after being filled, the first port 102 and the second port 104 may be closed via caps, covers, etc. Additionally, in an embodiment, the ballasts may not be fluidly connected together, and in such instances, the second port 104 may be omitted. The first port 102 and/or the second port 104 may include quick disconnect features.

The ballast 100 may be designed with a vent 106 to allow air to escape during the filling process. The vent 106 helps prevent air pockets from forming inside the ballast 100, ensuring uniform material distribution, proper fill, and consistent weight. By facilitating controlled air release, the vent 106 improves filling efficiency, reduces the risk of structural stress, and enhances the overall stability of the ballast 100.

Although a certain size, shape, and/or configuration of the ballast 100 is shown, other variations are envisioned. The size, shape, and/or configuration of the ballast 100 may be dependent upon the solar panel modules supported by the ballast 100. Moreover, although the first port 102 and the second port 104 are shown as being at a particular location, other locations are envisioned.

The first port 102 and the second port 104 may be enclosed or sealed with various connection components to control fluid flow and maintain system integrity. These components may include threaded or snap-on caps for temporary closure, specialized fittings such as couplings or adapters to interface with external tubing or piping systems, and valves of various types, including ball valves, gate valves, or check valves to regulate or prevent fluid passage. The selection of enclosure components depends on the specific application requirements, including pressure ratings, temperature ranges, chemical compatibility with the fluid being handled, and whether the connection needs to be permanent or readily accessible for maintenance and servicing operations.

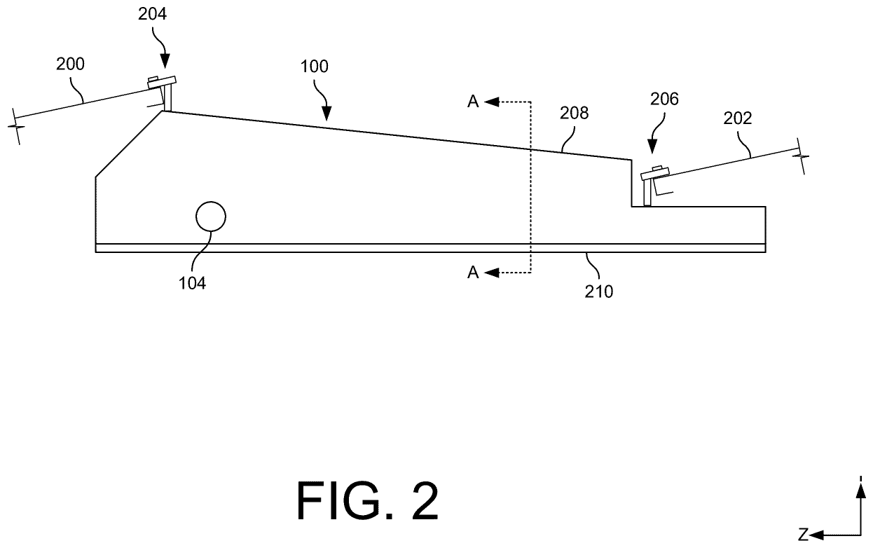

FIG. 2 illustrates a side view of the ballast 100, showing the ballast 100 supporting a first solar panel module 200 and a second solar panel module 202, according to an embodiment of the present disclosure. The ballast 100 may include a first mount 204 and a second mount 206. The first mount 204 and the second mount 206 may be disposed along a top 208 of the ballast 100. A bottom 210, opposite the top 208, may be disposed on the mounting surface (e.g., may rest on the mounting surface).

The first mount 204 and the second mount 206 may connect to the first solar panel module 200 and the second solar panel module 202, respectively, in any suitable manner. For example, the first mount 204 and the second mount 206 may represent clamps that clamp to the first solar panel module 200 and the second solar panel module 202, respectively. The first mount 204 and the second mount 206 may secure to the ballast 100 in any suitable manner (e.g., connectors, fasteners, etc.). Mounts other than the first mount 204 and the second mount 206 may be used to secure the first solar panel module 200 and the second solar panel module 202, respectively, to the ballast 100.

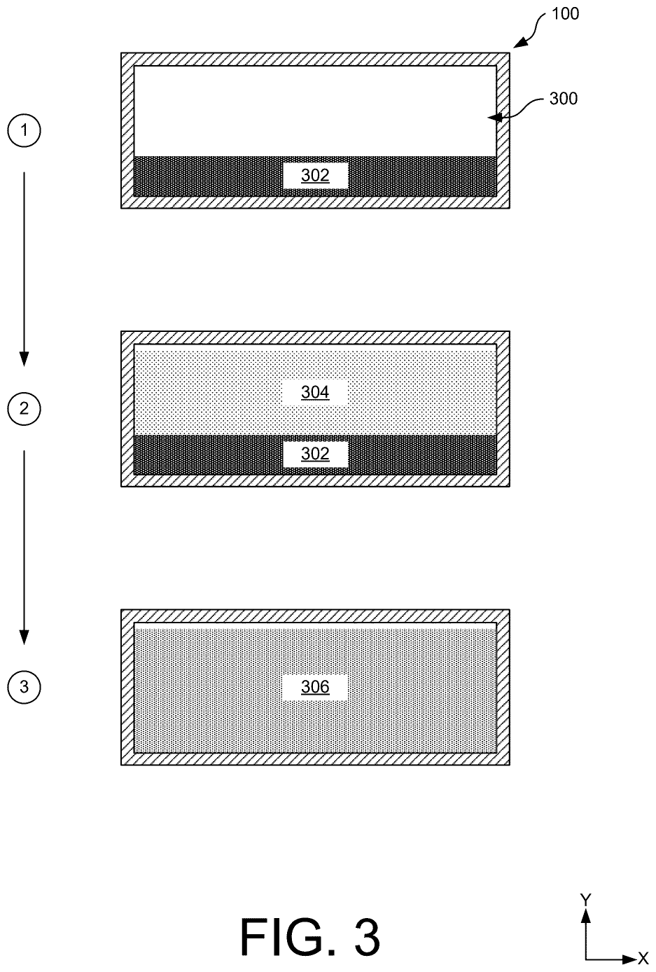

FIG. 3 illustrates a cross-sectional view, taken along line A-A of FIG. 2, showing a first example of filling the ballast 100, according to an embodiment of the present disclosure. At “1” in FIG. 3, a cavity 300 of the ballast 100 is shown containing a first substance 302, such as aggregate, which may be installed prior to filling the cavity 300 with another substance. In an embodiment, the first substance 302 may be installed prior to transporting the ballast 100 to the surface, at or during a time or manufacturing, etc. The first substance 302 may fill a portion of the cavity 300. At “2,” a second substance 304, such as water, may be pumped into the cavity 300 to interact with the first substance 302. Room within the cavity 300 may be left over to permit expansion of the first substance 302 and the second substance 304. Moreover, during this process, the vent 106 may release air from within the cavity 300 to prevent pressure buildup and ensure proper material distribution. At “3,” the combination of the first substance 302 and the second substance 304 substantially fills the cavity 300, forming a third substance 306 having an integrated mass that provides weight and stability to the ballast 100. This configuration facilitates efficient filling, minimizes trapped air pockets, and enhances overall structural integrity. The first substance 302 and the second substance 304 are exemplary, and other substances are envisioned.

In an embodiment, the first substance 302 and the second substance 304 may mix via the velocity of the second substance 304 entering the cavity 300. The kinetic energy imparted by the incoming second substance 304 can create turbulent flow patterns within the cavity 300, promoting intimate contact and mixing between the two substances. The velocity at which the second substance 304 enters may be controlled or optimized based on factors such as the viscosities of both substances, the desired degree of mixing, and the geometry of the cavity 300. Higher entry velocities generally produce more vigorous mixing through increased shear forces and turbulence, while lower velocities may result in more gradual or stratified mixing depending on the density differences between the first substance 302 and the second substance 304.

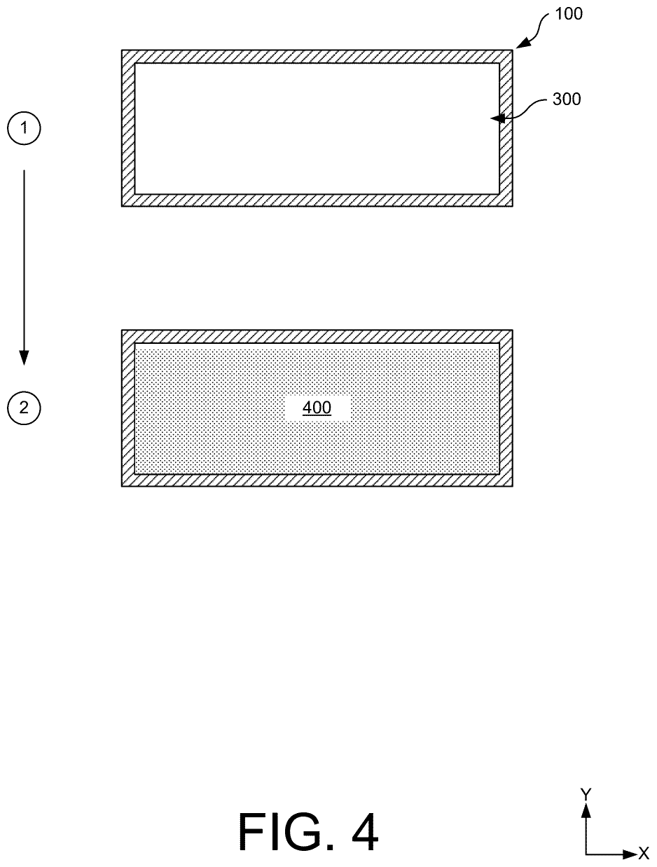

FIG. 4 illustrates a cross-sectional view, taken along line A-A of FIG. 2, showing a second example of filling the ballast 100, according to an embodiment of the present disclosure. At “1” in FIG. 4, the cavity 300 is shown to be empty. At “2” in FIG. 4, the cavity 300 may be filled with a substance 400. In some instances, the substance 400 includes an aggregate, slurry, or other pumpable substance. The substance 400 may be capable of being pumped or otherwise delivered into the cavity 300 via the first port 102. Once the cavity 300 is filled (or at least partially filled), a hose, conduit, etc., may be removed.

Although FIGS. 3 and 4 illustrate the process of filling a single ballast 100, the system is not limited to this configuration. In alternative implementations, multiple ballasts 100 may be filled either in parallel or in series. Parallel filling enables simultaneous material distribution across several ballasts, reducing overall installation time, while series filling allows sequential control for applications requiring staged or balanced loading.

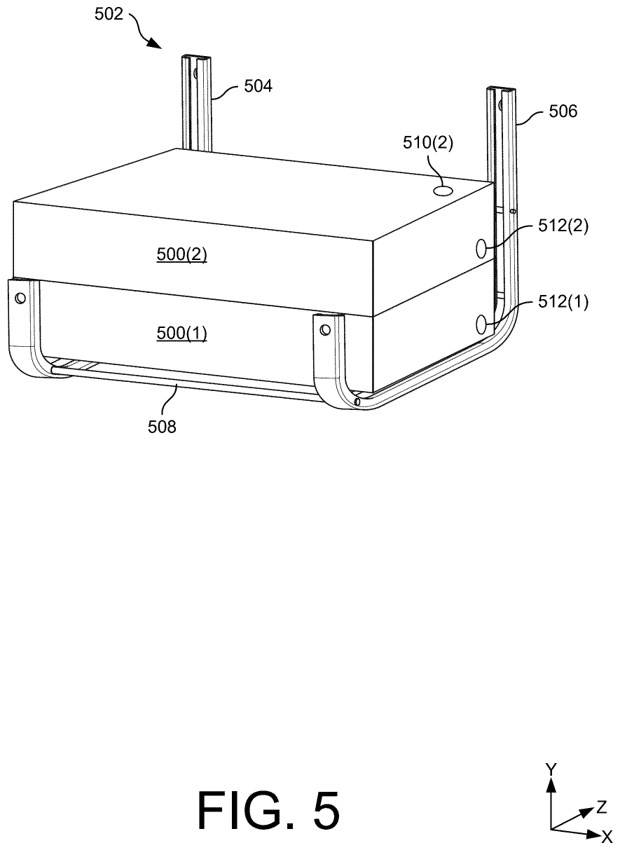

FIG. 5 illustrates example ballasts 500 that may be modular and/or stackable, according to an embodiment of the present disclosure. Compared to the ballasts 100, the ballasts 500 may not be integrated with a mount 502 that supports solar panel modules. For example, the ballast 500 may be a separate component from the mount 502.

In an embodiment, the ballasts 500 may include a first ballast 500(1) and a second ballast 500(2) that is stacked on top of the first ballast 500(1). The first ballast 500(1) may be positioned on the mount 502. For example, the mount 502 may include a first arm 504 and a second arm 506 that are connected via struts 508 (e.g., bars, members, etc.). The mount 502 may define a receptacle, platform, base, etc., into which the ballasts 500 are disposable. The solar panel modules may be secured to the mount 502, whether directly or indirectly (e.g., via rails, clamps, brackets, fasteners, etc.), and given the positioning of the ballasts 500 on the mount 502, the ballasts 500 support the solar panel modules.

As shown, the ballasts 500 may have a rectangular shape. In an embodiment, the ballasts may be secured together via interlocking features. For example, flanges, keys/keyways, male/female connectors, etc., may interlock, position, orient, etc., the ballasts 500 to one another. This may prevent the ballasts 500 from reorienting on the mount 502. In addition, the first ballast 500(1) may rest on the mount 502, or may engage with features of the mount 502 to position the first ballast 500(1). For example, slits, grooves, etc., may rest or engage with the first arm 504 and/or the second arm 506. In some instances, the ballasts 500 may have a footprint (e.g., in the X-Z plane) smaller than the mount 502. In an embodiment, rather than purely resting on the mount 502, the ballasts 500 may attach to the mount 502 via straps, cables, fasteners, etc.

The ballasts 500 may have a first port 510 and a second port 512. The first port 510 of the first ballast 500(1) is obscured via the second ballast 500(2). Each of the ballasts 500 has a cavity configured to be filled with a substance. In an embodiment, the cavities of the ballasts may be filled after installation or transportation of the ballasts 500 onto the mounting surface. In an embodiment, the cavities of the ballasts 500 may be individually filled and then, stacked on top of one another. Alternatively, the cavities may be filled via a fluid coupling between the cavity of the first ballast 500(1) and the second ballast 500(2).

For example, in an embodiment, the substance may flow into cavity via the first port 510(2) of the second ballast 500(2), and the second port 512(2) of the second ballast 500(2) may be fluidly connected to the second port 510(2) of the first ballast 500(1) via a hose, for example. Accordingly, the cavities may be filled simultaneously. However, in an embodiment, the cavities may be filled differently. In this instance, the first port (e.g., 510(1) may be obscured, enclosed, etc. For example, the second port 512 may be located differently, such as on a bottom of the ballast 500, whereby the second port 512 is positioned to be in fluid communication with the first port 510. The substance may flow between the first port 510 and the second port 512 to permit the first ballast 500(1) and the second ballast 500(2) to be filled in series.

Although the ballasts 500 are shown as including the first ballast 500(1) and the second ballast 500(2), more than two of the ballasts 500 may be stacked on top of one another. Moreover, even though the ballasts 500 are described as stacking, the ballasts 500 may be arranged in other manners (i.e., not stacked). Additionally, the ballasts 500 may take other shapes rather than being rectangular. For example, the shape of the ballasts 500 may accommodate a shape of the mount 502.

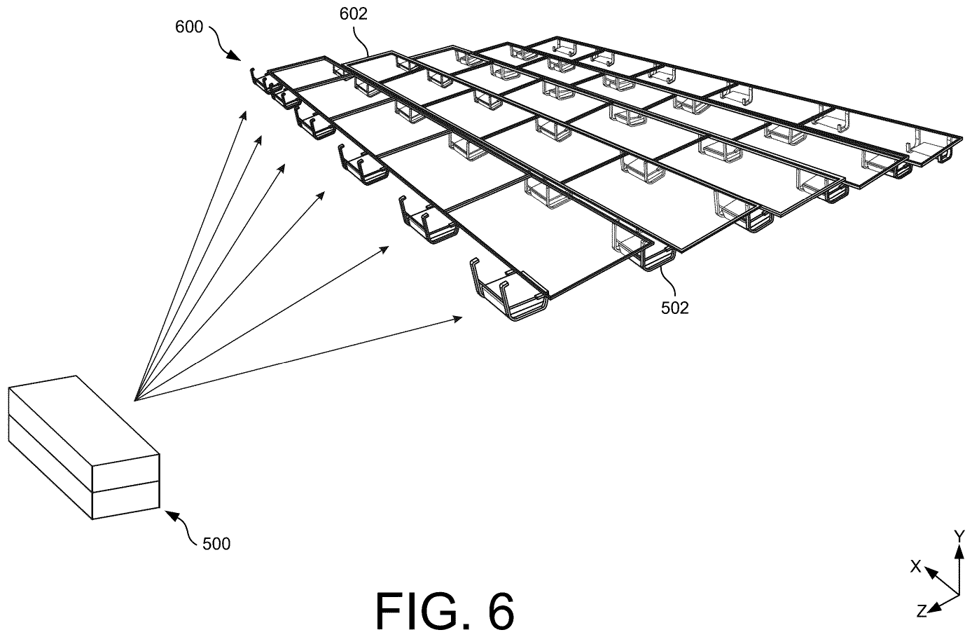

FIG. 6 illustrates an example use of the ballasts 500 within a mounting system 600, according to an embodiment of the present disclosure. As shown, solar panel modules 602 may be supported by one or more of the mounts 502. In an embodiment, more than one of the mounts 502 may support more than one of the solar panel modules 602. The ballasts 500 may be disposed within receptacles of each of the mounts 502, respectively. In an embodiment, the ballasts 500 may be disposed within the mounts 502 after attaching the solar panel modules 602 to the mounts 502, or before attaching the solar panel modules 602 to the mounts 502. Although the use of two of the ballasts 500 is shown, more or fewer than two of the ballasts 500 may be used. Moreover, each of the mounts 502 may have a different number of the ballasts 500. The ballasts 500 may be filled with the substance prior to, or after, installation onto the mounts 502. In an embodiment, the ballasts 500 may be individually filled or collectively filled.

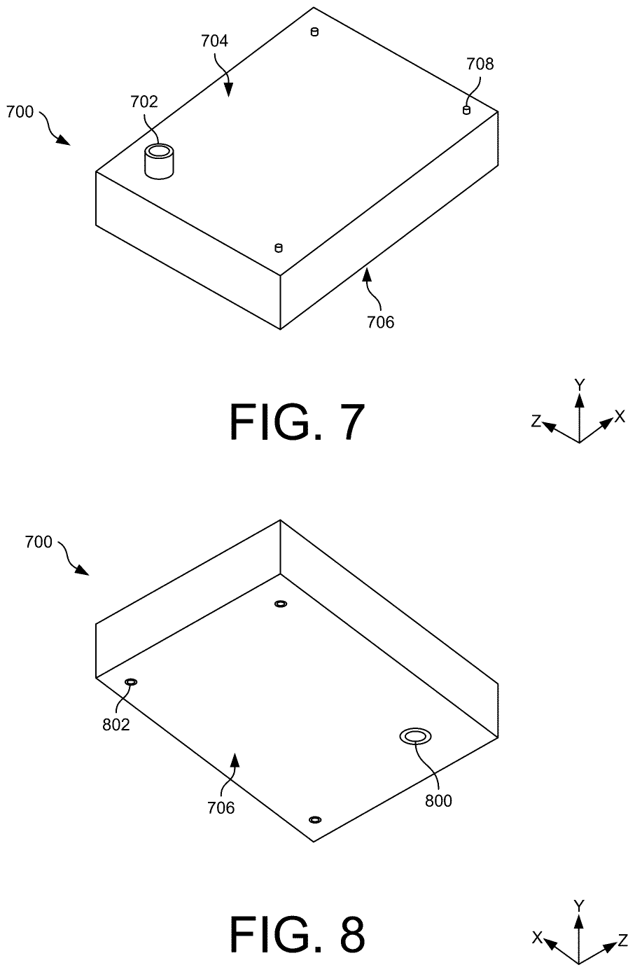

FIG. 7 illustrates a top isometric view of an example ballast 700 that may be modular and/or stackable in nature, according to an embodiment of the present disclosure. In an embodiment, the ballast 700 may include a connector 702 disposed along a top 704 of the ballast 700. The connector 702 may engage, connect, etc., with additional ballasts (e.g., another of the ballast 700), such that the ballasts 700 are stackable. Moreover, the ballast 700, although obscured in FIG. 7, may include a connector disposed along a bottom 706 that fluidly connects the ballast 700 to another of the ballasts 700.

The top 704 may include interlocking features 708 that engage with interlocking features disposed along the bottom 706. Engagement between the interlocking features 708 and the interlocking features on the bottom 706 may prevent reorientation of the ballasts 700 when in the stacked configuration.

FIG. 8 illustrates a bottom isometric view of the ballast 700, according to an embodiment of the present disclosure. As discussed above, the ballast 700 may include a connector 800 disposed along the bottom 606. The connector 800 is configured to engage with (e.g., receive) the connector 702. For example, the connector 702 may be disposed within the connector 800, to fluidly connect the ballast 700 with another of the ballasts 700. A fluid connection permits a substance to flow between the ballasts 700 when arranged in a stacked configuration.

The bottom 706 includes interlocking features 802 that engage with the interlocking features 708. In some instances, the interlocking features 708 represent prongs, tabs, etc., that are disposable within the interlocking features 802, which may represent receptacles, cavities, etc., respectively. Although certain interlocking features are shown, the interlocking features 708 and/or the interlocking features 802 may be different than those shown (e.g., ribs, channels, etc.), and/or the interlocking features 708 and/or the interlocking features 802 may be arranged differently than shown (e.g., number, layout, etc.).

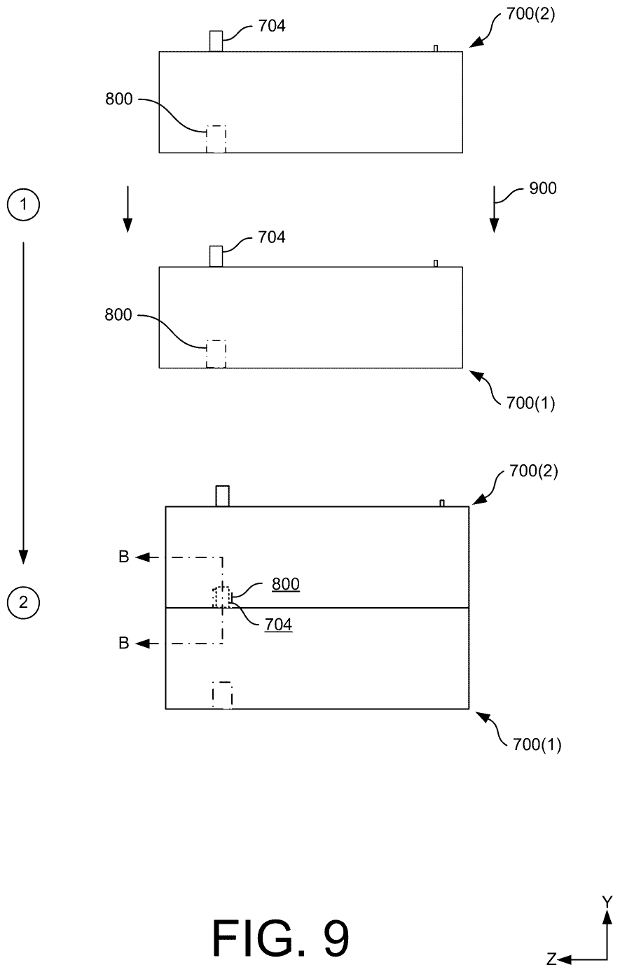

FIG. 9 illustrates an example coupling between a first ballast 700(1) and a second ballast 700(2) that is stacked on top of the first ballast 700(1), according to an embodiment of the present disclosure. At “1” in FIG. 9, the first ballast 700(1) and the second ballast 700(2) may be fluidly disconnected; however, when moved in a direction 900, the second ballast 700(2) may be disposed on top of the first ballast 700(1). The connector 702 and the connector 800 may fluidly engage to fluidly connect the first ballast 700(1) and the second ballast 700(2). For example, the connector 800 of the second ballast 700(2) may fluidly connect with the connector 702 of the first ballast 700(1).

In some instances, the connector 702 and the connector 800 may represent quick-connect mechanisms that fluidly connect the first ballast 700(1) and the second ballast 700(2). When stacked together, the connector 702 of the first ballast 700(1) may engage with the connector 800 of the second ballast 700(2). Through this connection, the substance may flow from the cavity of the second ballast 700(2) to the cavity of the first ballast 700(1). For example, a hose may fluidly connect to the connector 702, flow into the cavity of the second ballast 700(2), and then into the cavity of the first ballast 700(1). As the cavity of the first ballast 700(1) fills with the substance, the substance may no longer flow into the cavity of the first ballast 700(1), and the cavity of the second ballast 700(2) may be filled.

When not engaged, the connector 702 and the connector 800 may seal the cavity. For example, when the connector 702 does not engage with the connector 800, such as depressing a collar, seal, ring, etc., of the connector 800, the cavity may be sealed. Although described as quick disconnects, the connector 702 and the connector 800 may represent other fittings, valves, orifices, connections, etc., that fluidly connect the cavities.

In various embodiments, alternative connector configurations may be employed to facilitate fluid transfer between stacked ballasts while maintaining automatic sealing when disconnected. For instance, the connector 702 and the connector 800 may include cam-lock couplings that utilize cam arms to secure mating components together and create a fluid-tight seal. When engaged, the cam arms rotate to lock the male and female portions together, opening internal passages for substance flow, while disengagement causes spring-loaded seals or check valves to automatically close and prevent leakage from either ballast.

In another embodiment, the connectors may utilize self-sealing dry-break couplings that incorporate spring-loaded poppet valves within both the male and female connector halves. Upon connection, the opposing poppet valves are mechanically pushed open against their spring forces, allowing fluid communication between the first ballast 700(1) and the second ballast 700(2). When the connectors are separated, the springs immediately return the poppet valves to their closed positions, sealing both openings and preventing spillage of the substance from either cavity. This configuration is particularly advantageous when the ballasts need to be frequently connected and disconnected for modular installations or maintenance operations.

Alternatively, magnetic coupling systems may be employed wherein the connector 702 and the connector 800 contain magnetic elements that align and secure the connection through magnetic attraction. These magnetic couplings may incorporate elastomeric seals or O-rings that compress when the magnetic force pulls the connector halves together, creating a fluid-tight seal. Internal ball valves, gate mechanisms, or sleeve valves within each connector half may be mechanically actuated by the mating process to open fluid passages and automatically return to closed positions when the connectors are separated and the magnetic attraction is released.

In an embodiment, a portion of the ballast 700 within the connector 800 may be pierced to allow for insertion of the connector 702 of the first ballast 700(1) into the connector 800 of the second ballast 700(2). This piercing mechanism may function similarly to a needleless IV connector or a sealed septum fitting, wherein a probe or male connector element penetrates through a self-sealing membrane, diaphragm, or septum material such as silicone rubber or other elastomeric compounds. Upon withdrawal of the connector 702, the elastomeric material of the connector 800 automatically reseals due to its inherent resilience and memory properties, thereby preventing leakage from the cavity of the second ballast 700(2). This piercing configuration eliminates the need for mechanical valve components while still providing effective sealing in both connected and disconnected states.

The ballasts may include first ballasts (e.g., the ballasts 700) having both the connector 702 and the connector 800, as well as second ballasts that only have the connector 702. The first ballasts may be stackable, allowing them to connect to one another in a vertical configuration. However, a bottom-most ballast in the stack may comprise one of the second ballasts, which lacks the connector 800, thereby preventing the substance from leaking out through the bottom of the assembled stack. This configuration enables modular stacking while maintaining containment integrity at the base of the system.

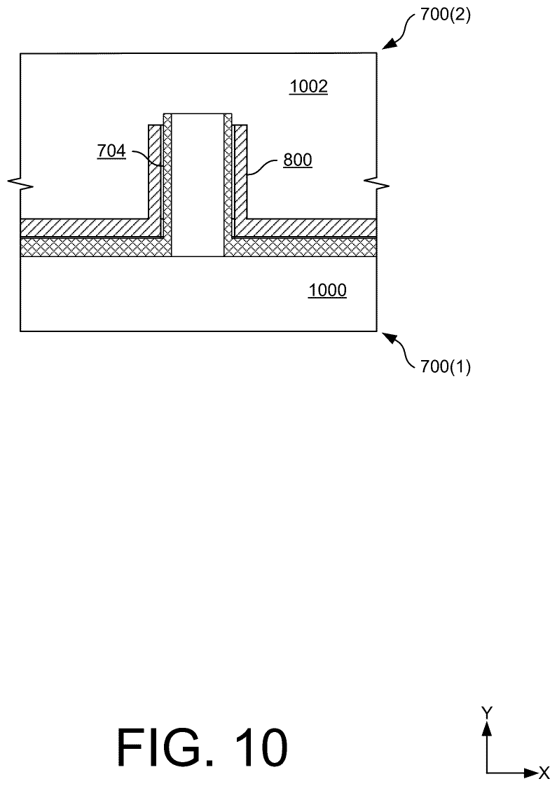

FIG. 10 illustrates a cross-sectional view of the first ballast 700(1) and the second ballast 700(2), taken along line B-B of FIG. 9, according to an embodiment of the present disclosure. As introduced above, a cavity 1000 of the first ballast 700(1) may be fluidly connected to a cavity 1002 of the second ballast 700(2). For example, the connector 702 of the first ballast 700(1) may be disposed within the connector 800 of the second ballast 700(2), thereby establishing fluid communication between the first ballast 700(1) and the second ballast 700(2).

The connector 702 may include a male connector element, such as a probe, piercing stem, insertion tube, or luer-type fitting, while the connector 800 may include a corresponding female connector element, such as a receptacle, port housing, self-sealing valve assembly, or septum-based fitting. In various embodiments, the connector 702 and the connector 800 may be configured as quick-disconnect fittings, push-to-connect couplings, threaded connectors, bayonet-style fittings, or self-sealing needle-free connections that facilitate rapid assembly and disassembly of the stacked ballast configuration. The connector 702 and the connector 800 include orifices, openings, passages, or channels that are of sufficient size to permit liquid, substance, or other fill material to flow between the cavity 1000 and the cavity 1002. The dimensions of these orifices may be selected based on the viscosity of the substance, desired fill rate, and pressure conditions to ensure efficient fluid transfer while maintaining the structural integrity of the connectors.

As shown, the connector 702 may be disposed through the connector 800, for example, by piercing or penetrating a self-sealing membrane, elastomeric septum, or valve element contained within the connector 800. This piercing action opens a fluid pathway between the cavity 1000 and the cavity 1002, allowing the substance to flow from the second ballast 700(2) into the first ballast 700(1) during filling operations. The engagement between the connector 702 and the connector 800 creates a sealed interface that prevents leakage during fluid transfer.

Moreover, although described as fluidly connecting two of the ballasts 700, more than two of the ballasts 700 may be fluidly connected in a similar manner. For example, three, four, five, or more ballasts may be stacked vertically with each ballast incorporating corresponding connectors that engage with adjacent ballasts to create a series of fluid pathways through multiple cavities. This modular stacking configuration allows for scalable weight capacity and simplified filling procedures wherein a single fill operation can sequentially or simultaneously fill multiple ballasts.

It should be understood that the connector 702 and the connector 800, as well as their engagement mechanism, are exemplary and may be substituted with alternative connection technologies that provide equivalent functionality. Different connector types, valve configurations, or sealing arrangements may be employed depending on the specific application requirements, substance properties, pressure ratings, and desired ease of assembly.

When not engaged, the connector 800 holds the substance within the cavity 1000. For example, when the connector 702 is withdrawn or not inserted, the connector 800 of the first ballast 700(1) automatically seals to prevent the substance from escaping the cavity 1000. This self-sealing functionality may be achieved through spring-loaded valves, elastomeric membranes that reseal after piercing, or other passive sealing mechanisms that close the fluid pathway in the absence of an engaged mating connector.

Additionally, a hose, fitting, tube, or other fluid delivery apparatus may engage with the connector 702 of the second ballast 700(2) for disposing the substance into the cavity 1002. This external connection allows the substance to be pumped, poured, or otherwise introduced into the uppermost ballast in the stack, from which it may flow downward through the series of interconnected cavities via the engaged connectors until all ballasts in the stack are filled to the desired level.

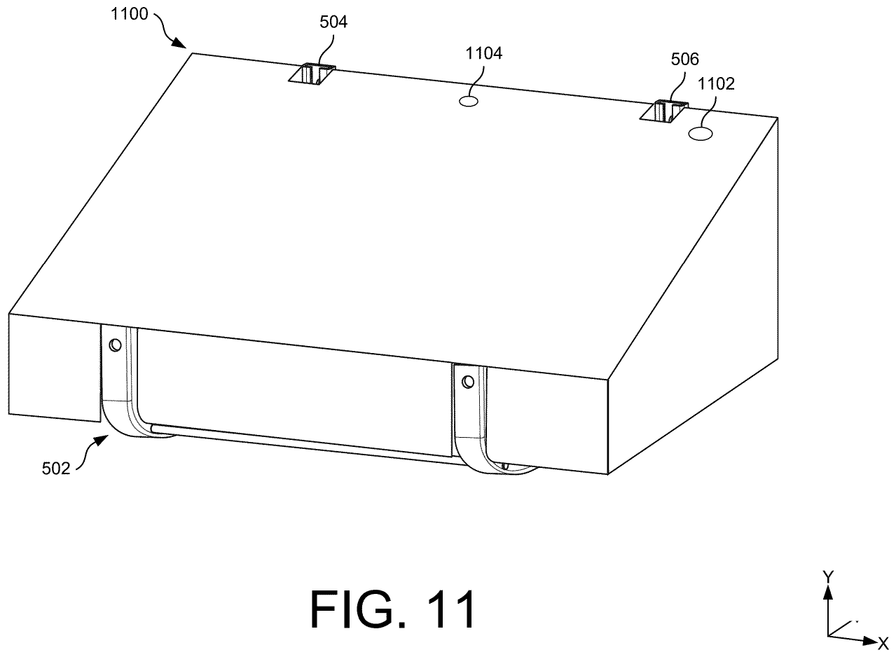

FIG. 11 illustrates an example ballast 1100, according to an embodiment of the present disclosure. The ballast 1100, as shown, may be secured to the mount 502 as discussed above. In an embodiment, the ballast 1100 may extend beyond the sides of the mount 502, such as extending past a left side and a right side of the mount 502, including beyond the first arm 504 and the second arm 506. This extended configuration may provide increased stability, a lower center of gravity, or additional weight distribution to counteract wind uplift or other external forces acting on the solar panel modules. For example, rather than having multiple ballasts that provide weight to the mount 502, a single (i.e., larger) ballast may be used. The size, shape, dimensions, and proportions of the ballast 1100 are exemplary and may be modified to accommodate different mount configurations, installation requirements, or weight capacity needs. For instance, the ballast 1100 may be rectangular, trapezoidal, curved, or custom-shaped to conform to specific mounting surface geometries or spacing constraints.

The ballast 1100 includes a port 1102, such as an inlet, fill opening, or access point, to dispose the substance within a cavity of the ballast 1100. The port 1102 may be positioned on a top surface, side wall, or other accessible location of the ballast 1100 to facilitate connection with hoses, pumps, or gravity-fed filling systems. The port 1102 may incorporate threaded fittings, quick-connect couplings, or other attachment mechanisms to secure fluid delivery equipment during filling operations. Additionally, the ballast 1100 may include a vent 1104, an air release valve, or a breather opening that permits air or gases to escape from the cavity as the substance is introduced. The vent 1104 prevents air lock conditions, ensures complete filling of the cavity, and may also serve to equalize internal pressure with atmospheric pressure, thereby preventing deformation or structural stress on the ballast walls during filling and draining procedures.

Similar to the other ballasts described herein, the ballast 1100 may be filled with the substance to provide weight for supporting the solar panel modules connected to the mount 502. However, unlike the stackable ballasts 500 or 700, for example, the ballast 1100 may be configured as a single, non-stackable unit designed to provide a predetermined weight capacity without requiring modular assembly or vertical stacking.

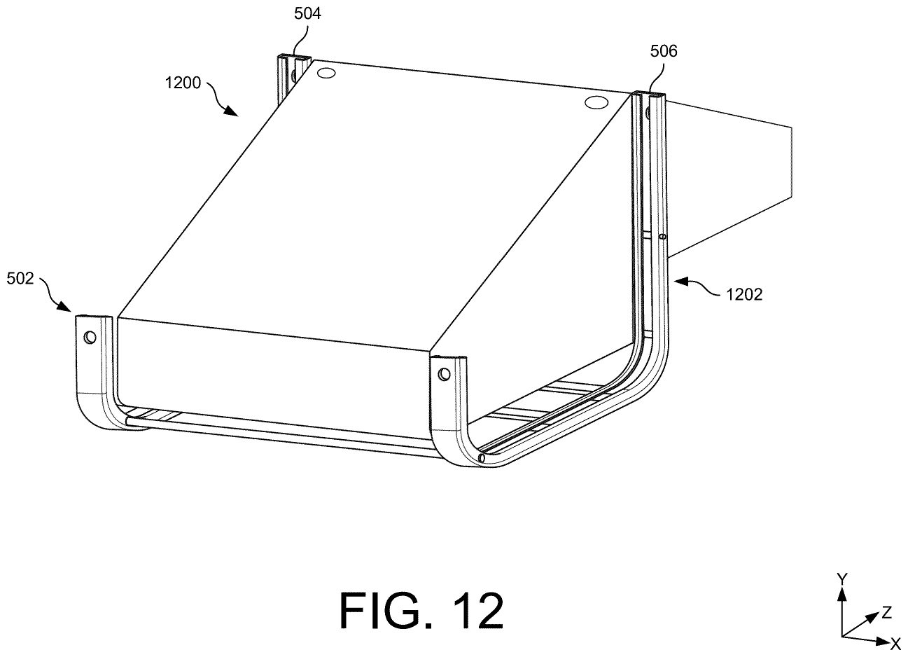

FIG. 12 illustrates an example ballast 1200, according to an embodiment of the present disclosure. The ballast 1200, as shown, may be secured to the mount 502 as discussed above. In an embodiment, the ballast 1200 may be shaped and sized according to the mount 502 or according to specific installation requirements and weight distribution objectives. The size, shape, dimensions, and configuration of the ballast 1200 are exemplary and may be modified to accommodate different mounting systems, rooftop geometries, or structural load requirements. For example, the ballast 1200 may extend beyond a back 1202 of the mount 502 to provide added weight, enhanced stability, or improved resistance to rearward tipping forces that may result from wind loading on the solar panel modules. This rearward extension may increase the effective moment arm and counterbalancing effect of the ballast weight relative to pivot points or support locations on the mount 502.

The ballast 1200 includes a port and a vent, similar to the ballasts described above, to facilitate filling the cavity with the substance and to allow air to escape during the filling process. Similar to the other ballasts described herein, the ballast 1200 may be filled with the substance to provide weight for supporting the solar panel modules connected to the mount 502. However, instead of being stackable like the ballasts 500 or 700, the ballast 1200 may not be stackable and may be configured as a single, integrated unit designed to provide a specific weight capacity without requiring modular assembly or vertical stacking arrangements.

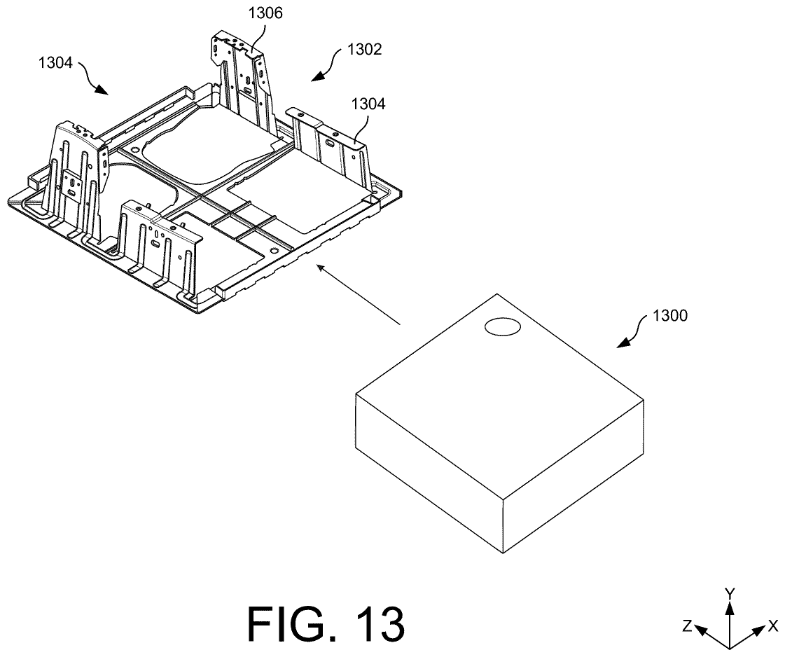

FIG. 13 illustrates an example ballast 1300 usable with an example mount 1302, according to an embodiment of the present disclosure. The mount 1302 may include a receptacle 1304 into which the ballast 1300 is configured to be disposed. The mount 1302, for example, may include supports to which the solar panel modules, rails, frames, or other structural components are attachable. For example, the mount 1302 may include one or more first supports 1306 and one or more second supports 1308 that connect, support, secure, or otherwise interface with the solar panel modules, rails, frames, or related mounting hardware.

The ballast 1300 is insertable into the receptacle 1304 either before or after being filled with the substance. The ballast 1300 may be shaped and sized to accommodate the receptacle 1304, providing a complementary fit that prevents lateral movement or displacement during wind events or other loading conditions. The size, shape, dimensions, and configuration of the ballast 1300 are exemplary and may be modified to suit different receptacle geometries or weight requirements. In an embodiment, the ballast 1300 may include a single ballast or multiple ballasts that connect together, whether through stacking, side-by-side placement, or other modular arrangements. The ballast 1300 includes a port and a vent, similar to the ballasts described above, to facilitate filling the cavity with the substance and to allow air to escape during the filling process.

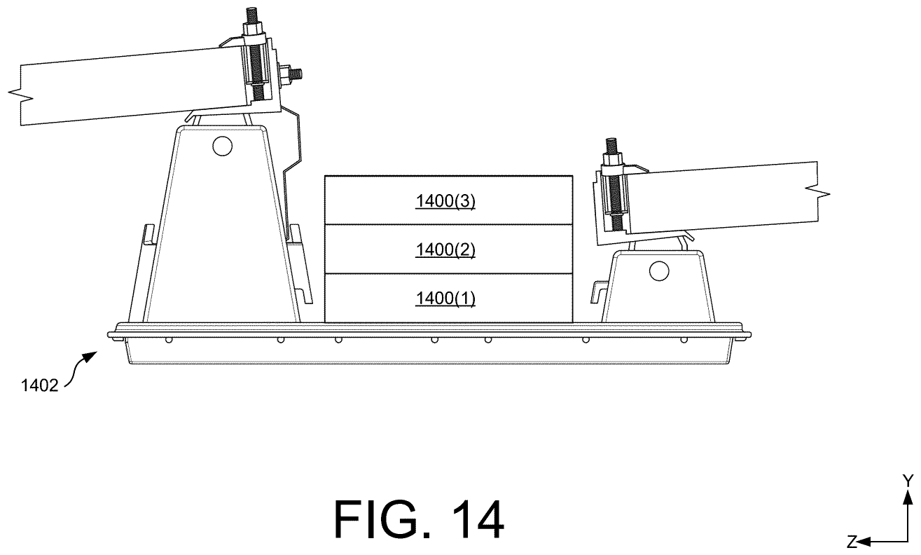

FIG. 14 illustrates example ballasts 1400 usable with an example mount 1402, according to an embodiment of the present disclosure. The mount 1402 may include a receptacle 1404 into which the ballasts 1400 are disposed. As shown, the ballasts 1400 may include a first ballast 1400(1), a second ballast 1400(2), and a third ballast 1400(3). The ballasts 1400 may be stackable, and each of the ballasts 1400 may include cavities into which the substance is disposed. As shown, the mount 1402 may include supports, brackets, arms, struts, or other structural elements for connecting to, supporting, or securing the solar panel modules.

In an embodiment, the ballasts 1400 may be fluidly connected to one another through connectors, ports, couplings, or other fluid transfer mechanisms as described above with reference to previous figures. This fluid connection allows the substance to flow between the cavities of the first ballast 1400(1), the second ballast 1400(2), and the third ballast 1400(3), enabling simultaneous or sequential filling of multiple ballasts through a single fill operation. Alternatively, the ballasts 1400 may be fluidly disconnected from one another, wherein each ballast is filled independently through its own port or inlet without fluid communication between the individual cavities. The choice between fluidly connected or fluidly disconnected configurations may depend on installation preferences, filling equipment availability, desired fill rates, or maintenance requirements. Each of the ballasts 1400 includes a port and a vent, similar to the ballasts described above, to facilitate filling and air release during the filling process.

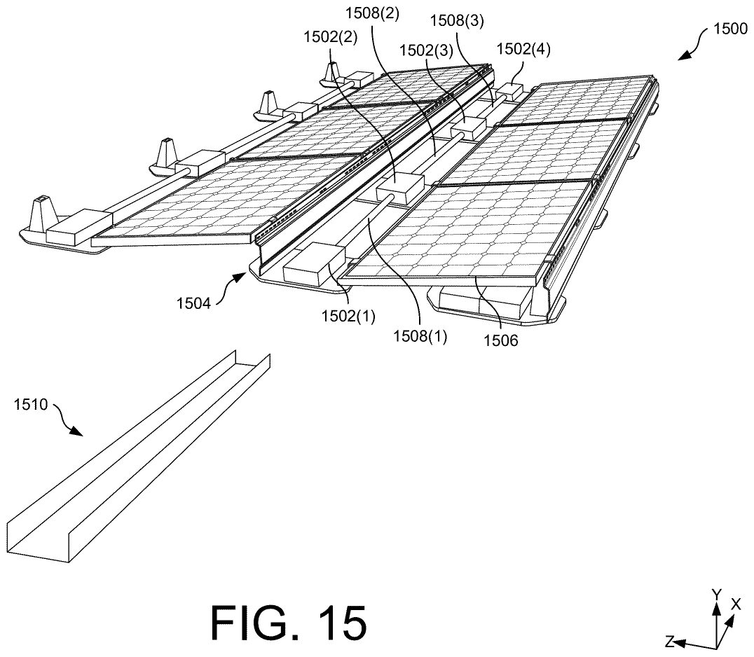

FIG. 15 illustrates an example mounting system 1500 for supporting solar panel modules, according to an embodiment of the present disclosure. In an embodiment, the mounting system 1500 may include ballasts 1502 and mounts 1504 that connect solar panel modules 1506 to the mounts 1504. The ballasts 1502 may be fluidly connected to one another such that substance may flow from one ballast 1502 to another. Pipes, conduits, hoses, fittings, etc., may fluidly connect the ballasts 1502 to one another. A first pipe 1508(1) may fluidly connect a first ballast 1502(1) and a second ballast 1502(2), a second pipe 1508(2) may fluidly connect the second ballast 1502(2) to a third ballast 1502(3), and a third pipe 1508(3) may fluidly connect the third ballast 1502(3) to a fourth ballast 1502(4). The mounting system 1500 may include other ballasts that are interconnected in a similar manner. For example, the ballasts may be arranged as rows, and the ballasts within the rows may be fluidly connected to one another.

In an embodiment, the ballasts 1502 may be similar to those discussed herein. For example, the pipe 1508 may be disposed between ports of the ballasts 1502 to fluidly connect the ballasts 1502.

In an embodiment, a tray 1510 may be disposed across the mounts 1504, or the tray 1510 may be disposed on a surface (e.g., roof), and mounts, brackets, etc., may connect to the tray. The ballasts 1502 may be disposed within the tray, and given that the ballasts 1502 are disposed within the tray, the ballasts 1502 provide weight to the tray for anchoring the solar panel modules 1506 to the surface. In such instances, the ballasts may be a tube-like structure that is unrolled within the tray, and the ballast may be filled with the substance. In this embodiment, the pipes may be omitted as the ballast 1502 may be continuous along a length of the tray.

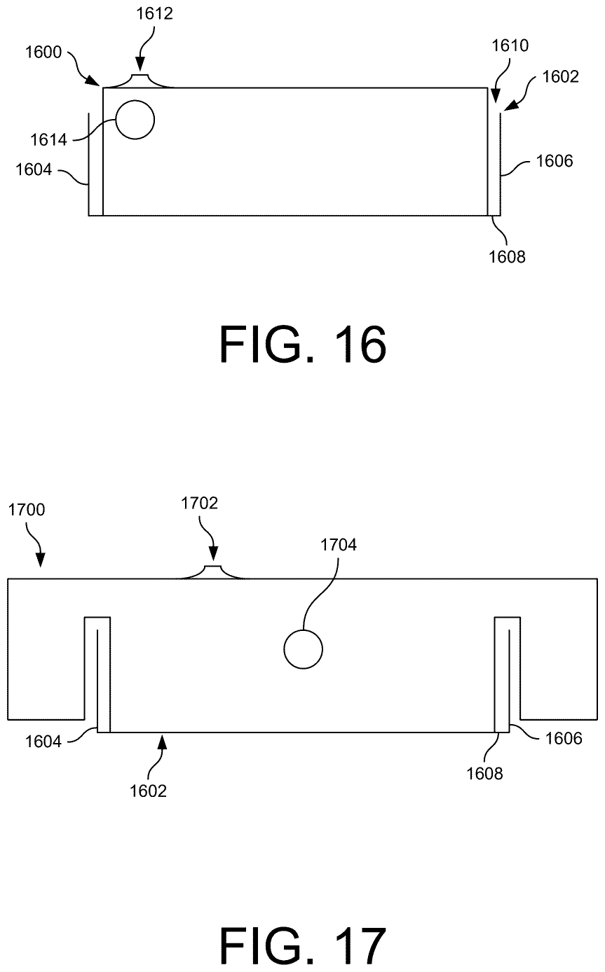

FIG. 16 illustrates an example ballast 1600 that may be useable with a tray 1602 (similar to the tray 1510), according to an embodiment of the present disclosure. For example, as discussed above, the tray 1602 may be disposed across mounts, or the tray 1602 may be positioned on a surface. The tray 1602 may include a first sidewall 1604 and a second sidewall 1606 that extend upwardly from a base 1608. The first sidewall 1604, the second sidewall 1606, and the base 1608 may define a receptacle 1610 in which the ballast 1600 is disposed. The receptacle 1610 provides a containment area that confines the ballast 1600 within the tray 1602, preventing lateral movement or displacement during installation, filling operations, or under environmental loading conditions such as wind or seismic events. The first sidewall 1604 and the second sidewall 1606 may be positioned parallel to one another or at angles that conform to the shape of the ballast 1600, and may extend along the length of the tray 1602 to accommodate one or multiple ballasts in series.

The ballast 1600 may be shaped and sized to fit within the receptacle 1610, with dimensions that allow for proper positioning and may include clearances for thermal expansion, manufacturing tolerances, or access to ports and fittings. The ballast 1600 includes a cavity configured to receive and retain the substance, thereby providing the necessary weight to anchor and resist uplift forces acting on the solar panel modules.

The ballast 1600 may include a first port 1612 for receiving the substance. The first port 1612 may serve as an inlet, fill opening, or connection point through which the substance is introduced into the cavity of the ballast 1600 via hoses, conduits, pipes, pumps, or gravity-fed filling systems. The first port 1612 may be positioned on a top surface, side wall, or end of the ballast 1600 to provide convenient access during filling operations. The first port 1612 may incorporate threaded fittings, quick-connect couplings, camlock connectors, or other attachment mechanisms to securely interface with fluid delivery equipment.

In addition, the ballast 1600 may include a second port 1614 that may be used to fluidly connect the ballast 1600 to other ballasts disposed along the tray 1602. For example, a hose, pipe, conduit, or flexible tube may route from the second port 1614 to a first port of another ballast positioned adjacent to or downstream from the ballast 1600. This fluid connection enables the substance to flow from one ballast to another, allowing multiple ballasts to be filled in sequence or simultaneously from a single fill point. The second port 1614 may be positioned on an opposite end, side, or surface of the ballast 1600 relative to the first port 1612 to facilitate efficient routing of interconnecting hoses or pipes between adjacent ballasts. The second port 1614 may similarly incorporate threaded fittings, quick-connect couplings, or other standardized connection interfaces to ensure leak-free and secure connections during filling and operational use.

The ballast 1600 may also include a vent, air release valve, or breather opening to allow air or gases to escape from the cavity as the substance is introduced through the first port 1612. The vent prevents air lock conditions that could impede filling, ensures complete filling of the cavity to maximize weight capacity, and equalizes internal pressure with atmospheric pressure to prevent deformation or stress on the walls of the ballast 1600.

FIG. 17 illustrates an example ballast 1700 that may be useable with the tray 1602, according to an embodiment of the present disclosure. The ballast 1700 is at least partially disposed within the receptacle 1610 of the tray 1602. For example, a first portion of the ballast 1700 may be disposed within the receptacle 1610, a second portion of the ballast 1700 may be disposed external to the receptacle 1610, along the first sidewall 1604, and a third portion of the ballast 1700 may be disposed external to the receptacle 1610, along the second sidewall 1606.

The ballast 1700 may include a first port 1702 for receiving the substance (e.g., via hoses, conduits, etc.) and a second port 1704 that may be used to fluidly connect the ballast 1700 to other ballasts disposed along the tray 1602.

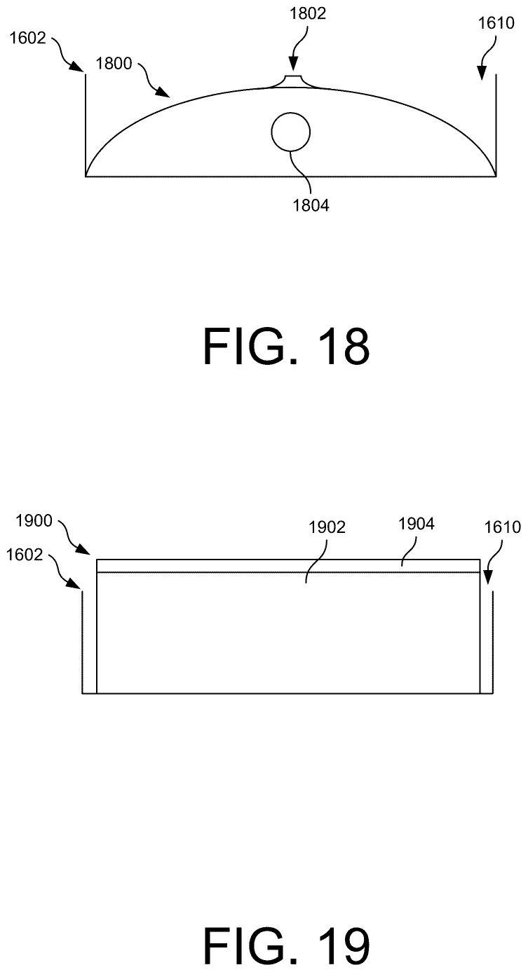

FIG. 18 illustrates an example ballast 1800 that may be useable with the tray 1602, according to an embodiment of the present disclosure. The ballast 1800 is at least partially disposed within the receptacle 1610 of the tray 1602. Compared to the previous ballasts, the ballast 1800 may be manufactured from a non-rigid material. For example, the ballast 1800 may be manufactured from rubber or plastic and may at least partially deform to take the shape of the receptacle 1610. In an embodiment, the ballast 1800 may represent a tube-like structure that is unrolled from a roll of material. In an embodiment, the ballast 1800 may be continuous along the length of the tray 1602, or a plurality of ballasts 1600 may be disposed along the length of the tray 1602. The ballast 1800 may include a first port 1802 for receiving the substance (e.g., via hoses, conduits, etc.) and a second port 1804 that may be used to fluidly connect the ballast 1300 to other ballasts disposed along the tray 1602.

FIG. 19 illustrates an example ballast 1900 that may be useable with the tray 1602, according to an embodiment of the present disclosure. The ballast 1900 is at least partially disposed within the receptacle 1610 of the tray 1602. In an embodiment, the ballast 1900 may include a base 1902 and a lid 1904 that attaches to the base 1902. The lid 1904 may be removed, for example, to fill a cavity of the base 1902 with the substance. After being filled, the lid 1904 may be attached to the base 1902. Fasteners, connectors, clamps, etc., may be used to attach the lid 1904 to the base 1902.

Although FIGS. 16-19 illustrate a particular shape of the tray 1602, other trays are envisioned. For example, the sidewalls of the tray 1602 may be oriented differently than shown. Moreover, ballasts other than those described in FIGS. 11-14 may be used in conjunction with the tray 1602 or separately from the tray 1602. Additionally, a manifold (e.g., trunk, network of pipes, etc.) may be used to fill the ballasts. For example, the manifold may deliver the substance to the cavities of the ballasts in parallel or sequentially, where the ballasts may be disposed on the same mount or different mounts. The manifold may be configured to fill any number of ballasts in parallel or sequentially.

As discussed herein, the substance may fill the ballasts or the cavities of the ballasts. Suitable substances include material (e.g., sand, gel, etc.), aggregate (e.g., rocks), fluid, etc. Alternatively, in an embodiment, the substance may be a curable material. Alternatively, in an embodiment, the substance may be formed via combining or mixing two or more agents, materials, etc. For example, a first agent and a second agent may be mixed together to form the substance. In an embodiment, the substance may be flowable, pumpable, conveyable, etc., to permit the substance to flow between ballasts. Various pumps, chutes, augers, hoses, valves, machines, etc., may be used to deliver the substance to the ballasts.

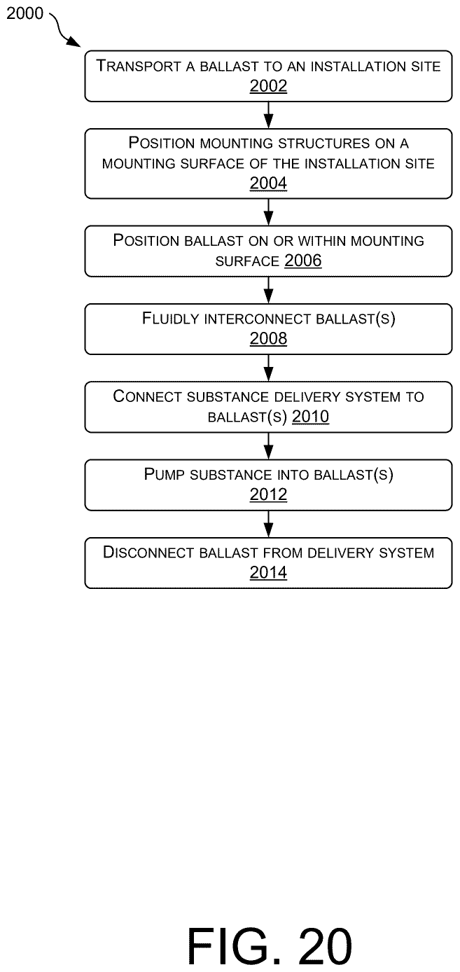

FIG. 20 illustrates a flowchart of a method 2000 for installing and filling a ballast system for supporting solar panel modules, according to an embodiment of the present disclosure.

At step 2002, empty ballast(s) may be transported to an installation site. Because the ballasts are empty, they are lightweight and do not require heavy lifting equipment such as cranes or forklifts. In an embodiment, the ballasts may be nested, stacked, or collapsed for efficient transportation.

At step 2004, mounting structures (e.g., rails, frames, mounts, stands, etc.) are positioned on the mounting surface (e.g., roof, ground). The mounting structures may be arranged in predetermined patterns or arrays corresponding to the solar panel layout. The mounting structures may include receptacles, platforms, or attachment points configured to receive or support the ballasts.

At step 2006, the empty ballasts are placed on or within the mounting structures. The ballasts may rest on platforms, be inserted into receptacles, be attached to mounting rails, etc. In embodiments using stackable, a first ballast may be positioned on the mounting structure, and additional ballasts may be stacked on top of the first ballast. In embodiments using integrated ballasts, the mounting structure and ballast may be positioned as a single unit. The ballasts may be temporarily secured using straps, clips, or other fasteners to prevent movement during subsequent installation steps. The placement of ballasts creates a secure foundation for supporting solar panel modules once the ballasts are filled with the substance.

At step 2008, the ballasts are fluidly interconnected using hoses, pipes, conduits, or quick-disconnect couplings. For example, a first port of a first ballast is connected to a second port of a second ballast using a connecting hose or pipe. Additional ballasts may be connected in series (daisy-chain configuration), parallel (manifold configuration), or hybrid configurations. In embodiments using stackable ballasts with integrated connectors, this step may occur automatically when ballasts are stacked together, with male and female connectors engaging to create fluid pathways between stacked units. In embodiments where ballasts are filled individually, this step may be omitted. The fluid interconnection allows multiple ballasts to be filled from a single connection point, significantly reducing installation time and labor.

At step 2010, a substance delivery system is connected to an initial ballast, typically the first ballast in a series or a central connection point in a manifold system. The substance delivery system may include a pump (e.g., centrifugal pump, positive displacement pump, diaphragm pump, pneumatic conveyor), a hose or conduit, and a substance supply source (tank, hopper, mixing station, supply truck). A delivery hose is connected to a fill port on the initial ballast using threaded connections, quick-disconnect couplings, cam-lock couplings, or other attachment mechanisms. The connection is secured to prevent leakage or disconnection during pumping operations. In embodiments where substance components are mixed during delivery, mixing equipment may be integrated into the delivery system between the supply source and the ballast.

At step 2012, the substance delivery system is activated to pump the substance into the ballast. The pump is started, and the substance begins flowing through the delivery hose into the first ballast (or a cavity thereof). Pumping parameters such as flow rate and pressure are monitored and adjusted as needed to prevent over pressurization, ensure complete filling, and optimize installation efficiency. In embodiments using particulate substances delivered as slurry, water content is controlled to achieve desired flowability while maintaining adequate solids content. In embodiments using curable substances, components may be mixed in-line immediately before delivery, with mixing ratios controlled to achieve desired curing characteristics. In embodiments using expandable foam, components are metered and mixed to initiate expansion within the ballast cavity. Pumping continues until the ballasts reach their pre-designed fill level, as indicated by visual observation, sensor feedback, overflow detection, or predetermined volume delivery. In interconnected systems, substance flows from the initial ballast to subsequent ballasts through the interconnecting hoses or pipes, filling multiple ballasts sequentially or simultaneously, depending on system configuration.

At step 2014, substance delivery is terminated after all ballasts have been filled to design capacity. The pump is shut off, and the substance flow ceases. In systems with automatic shutoff mechanisms, flow may be terminated automatically by solenoid valves responding to sensor signals, float valves that mechanically close when fill level is reached, or control system commands based on volume calculations or elapsed time. In manual systems, an operator observes fill indicators and shuts off the pump when filling is complete. Residual substance in delivery hoses may be purged back to the supply source using compressed air or reverse pumping, or may be discharged into a collection container to prevent waste. In embodiments using curable substances, any remaining mixed material in delivery lines may be flushed with solvent or water before curing occurs, or may be allowed to cure in place if disposable hoses are used. Proper termination prevents overfilling, spillage, and waste of substance.

At step 2014, delivery hoses are disconnected from the ballast after substance delivery has been terminated. Quick-disconnect fittings are released by pressing release collars or buttons, threaded connections are unscrewed, cam-lock arms are rotated to release, or other coupling mechanisms are disengaged according to their design. In embodiments with self-sealing ports featuring spring-loaded poppet valves or elastomeric sealing membranes, automatic sealing occurs upon disconnection, preventing substance loss without requiring separate caps. In embodiments requiring manual closure, caps or plugs are installed on fill ports and tightened to prevent substance loss, contamination, or unauthorized access. Interconnecting hoses between ballasts may be left in place to maintain fluid pathways for future substance additions or may be removed and capped, depending on design requirements and maintenance plans. Disconnected delivery hoses are inspected for damage, cleaned of residual substance using water or appropriate solvents, coiled properly to prevent kinking, and stored for future use. Proper disconnection and sealing ensure the ballast retains substance and maintains design weight throughout its service life.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated, and may include indirect connections through one or more intermediary elements. Likewise, the terms “directly” and “indirectly” describe both physical contact between components and connections made through intermediate structures, mechanisms, or devices.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A ballast for supporting solar panel modules, the ballast comprising:
a cavity;
a first port fluidly connected to the cavity and configured to receive a flowable substance; and
a second port fluidly connected to the cavity and configured to interconnect the cavity with an additional cavity of an additional ballast,
wherein the cavity is configured to be filled with the flowable substance provide weight to maintain the ballast in place with respect to a mounting surface.

2. The ballast of claim 1, further comprising one or more mounts configured to support a solar panel module of the solar panel modules.

3. The ballast of claim 1, wherein the flowable substance includes at least one of a particulate material, a liquid, an aggregate, or a curable concrete mixture.

4. The ballast of claim 1, further comprising first interlocking features configured to engage with second interlocking features of the additional ballast to secure the ballast and the additional ballast.

5. The ballast of claim 1, further comprising a substance disposed within the cavity.

6. The ballast of claim 5, wherein the substance is pre-installed within the cavity prior to transporting the ballast to the mounting surface.

7. The ballast of claim 1, further comprising a third port configured to vent air during filling of the cavity.

8. A solar panel mounting system comprising:
a mounting structure to support one or more solar panel modules above a mounting surface; and
a ballast disposed on or within the mounting structure, the ballast including:
a cavity,
a first port fluidly connected to the cavity whereby a substance is suppliable to the cavity to provide weight to the ballast, and
a second port fluidly connected to the cavity, the second port being configured to fluidly connect the cavity with an additional ballast.

9. The solar panel mounting system of claim 8, wherein the substance includes a flowable substance.

10. The solar panel mounting system of claim 8, wherein:
the substance is a first substance; and
the solar panel mounting system further comprises a second substance disposed within the cavity, the second substance being different than the first substance.

11. The solar panel mounting system of claim 8, further comprising a vent fluidly connected to the cavity.

12. The solar panel mounting system of claim 8, wherein the mounting structure includes a clamp to secure a solar panel module of the one or more solar panel modules to the ballast.

13. The solar panel mounting system of claim 8, further comprising:
a first connector disposed at the first port, the first connector to attach to a first fitting that supplies the substance; and
a second connector disposed at the second port, the second connector to attach to a second fitting that supplies the substance to the additional ballast.

14. The solar panel mounting system of claim 8, further comprising interlocking features configured to engage with corresponding interlocking features of the additional ballast.

15. A method of installing a ballasted solar panel system, the method comprising:
positioning ballasts on a mounting surface;
attaching mounting structures to the ballasts, respectively;
securing solar panel modules to the mounting structures;
fluidly interconnecting the ballasts; and
delivering a flowable substance to at least one ballast,
wherein the flowable substance provides weight to secure the solar panel modules to the mounting surface.

16. The method of claim 15, wherein the flowable substance includes at least one of a particulate material, a liquid, an aggregate, or a curable concrete mixture.

17. The method of claim 15, wherein:
the flowable substance is a first substance;
the ballasts are at least partially filled with a second substance that is different than the first substance; and
the second substance is disposed with the ballasts prior to positioning the ballasts on the mounting surface.

18. The method of claim 15, wherein the ballasts are disposed in a tray that is disposable across more than one of the mounting structures.

19. The method of claim 15, wherein the flowable substance is delivered to the ballasts in series.

20. The method of claim 15, wherein the flowable substance is pumpable into the at least one ballast.
